(19) United States
(12) Patent Application Publication
(10) Pub. No.: US 2009/0239150 A1
(43) Pub. Date: Sep. 24, 2009

(54) POSITIVE ELECTRODE ACTIVE MATERIAL FOR NONAQUEOUS ELECTROLYTE SECONDARY BATTERY AND NONAQUEOUS ELECTROLYTE SECONDARY BATTERY

(75) Inventors: Yukihiro Okada, Osaka (JP); Masatoshi Nagayama, Osaka (JP); Shigeru Hanaoka, Osaka (JP); Hidekazu Hiratsuka, Osaka (JP); Takahiro Okuyama, Osaka (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/300,618

(22) PCT Filed: Jun. 21, 2007
(86) PCT No.: PCT/JP2007/062959

§ 371 Date: Nov. 12, 2008

(30) Foreign Application Priority Data
Jun. 26, 2006 (JP) 2006-174823

(51) Int. Cl. H01M 4/50; H01M 4/52

(52) U.S. Cl. 429/231.3; 429/223; 429/224

(57) ABSTRACT

A Ni-containing positive electrode active material for a nonaqueous electrolyte secondary battery is formed of secondary particles each constituted by aggregated primary particles. In cross sections of the secondary particles, a total cross-sectional area of part of the primary particles at least partially exposed at the surfaces of the secondary particles is at least 40% of a total cross-sectional area of the primary particles constituting the secondary particles.

### TECHNICAL FIELD

The present invention relates to positive electrode active materials for nonaqueous electrolyte secondary batteries, and particularly relates to a nonaqueous electrolyte secondary battery whose positive electrode contains a specific positive electrode active material.

### BACKGROUND ART

With recent demands for higher capacity of batteries, nonaqueous electrolyte secondary batteries have received much attention. To achieve higher capacity of the nonaqueous electrolyte secondary batteries, positive electrode active materials have been investigated. One of the currently-used positive electrode active materials is a lithium composite oxide containing Co (i.e., a Co-based material such as LiCoO₂). Further, in terms of cost, life, and power of nonaqueous electrolyte secondary batteries, a lithium composite oxide containing Ni (i.e., a Ni-based material), a lithium composite oxide containing Mn (i.e., a Mn-based material), and a lithium composite oxide containing both Ni and Mn (i.e., a mixed oxide-based material) have also been investigated (see, for example, Patent Documents 1 and 2).

In Patent Document 1, crystal particles which contains Ni and Mn having substantially the same mole fraction and have a particle size of 0.1 μm to 2 μm and secondary particles which are formed of aggregation of the crystalline particles and have a particle size of 2 μm to 20 μm are mixed to be used as a positive electrode active material. Manufacturing of nonaqueous electrolyte secondary batteries by using such a positive electrode active material has achieved higher power and longer life than those in the case of using a conventional positive electrode active material (LiCoO₂), while maintaining low cost and high capacity.

In Patent Document 2, a positive electrode active material expressed as LiNi_{(1-(x+y))}CoₓM_{y}O₂ in which the average particle size of primary particles is 0.3 μm to 1 μm and the average particle size of secondary particles is 5 μm to 15 μm is used, thereby improving power characteristics of a nonaqueous electrolyte secondary battery especially at low temperatures.

Patent Document 1: Japanese Laid-Open Patent Publication No. 2002-42813

Patent Document 2: Japanese Laid-Open Patent Publication No. 2004-87492

### DISCLOSURE OF INVENTION

### Problems that the Invention is to Solve

Although Patent Documents 1 and 2 show improvement of power characteristics, further improvement of power characteristics are still needed. It is generally thought that when a Co-based material is used as a positive electrode active material, power characteristics are changed by changing the particle size of secondary particles. However, it is unknown and needs to be studied whether power characteristics are also changed by changing the particle size of secondary particles for a Ni-based material.

When cycles of charging/discharging a nonaqueous electrolyte secondary battery are performed, the positive electrode active material thereof repeats expansion and contraction. Accordingly, the positive electrode active material made of secondary particles can be divided into a plurality of primary particles. In general, a conductive agent is provided on the surfaces of the secondary particles. As disclosed in Patent Documents 1 and 2, when primary particles are excessively smaller than secondary particles, primary particles located inside the secondary particles are not exposed at the surfaces of the secondary particles. Thus, the surfaces of the primary particles inside the secondary particles are not coated with the conductive agent. Accordingly, in a case where the primary particles are excessively smaller than the secondary particles, when each of the secondary particles is divided into a plurality of such primary particles, conductivity of a positive electrode cannot be ensured. As a result, the use of the positive electrode active materials disclosed in Patent Documents 1 and 2 might shorten the life of nonaqueous electrolyte secondary batteries.

It is therefore an object of the present invention to provide a positive electrode active material for a nonaqueous electrolyte secondary battery and a nonaqueous electrolyte secondary battery exhibiting excellent power characteristics and cycle characteristics and long life.

### Means of Solving the Problems

To achieve the object, a positive electrode active material for a nonaqueous electrolyte secondary battery according to the present invention is a positive electrode active material containing Ni. The positive electrode active material is formed of secondary particles each constituted by aggregated primary particles. In cross sections of the secondary particles, a total cross-sectional area of part of the primary particles at least partially exposed at the surfaces of the secondary particles is at least 40% of a total cross-sectional area of the primary particles constituting the secondary particles.

With this structure, a large part of primary particles constituting secondary particles are exposed at the surfaces of the secondary particles and, thereby, are allowed to be in contact with a nonaqueous electrolyte. The increase in amount of primary particles in contact with the nonaqueous electrolyte improves power characteristics of a nonaqueous electrolyte secondary battery.

In addition, most of the primary particles exchange lithium ions directly with the nonaqueous electrolyte without passing the lithium ions across boundaries between adjacent primary particles (i.e., particle boundaries), thus improving power characteristics of the nonaqueous electrolyte secondary battery.

Further, in general, conductivity is secured at the surfaces of secondary particles. Since a large part of the primary particles are exposed at the surfaces of the secondary particles in this structure, conductivity is secured at the surfaces of these primary particles. Accordingly, even when the positive electrode active material is divided into a plurality of primary particles through charge and discharge cycles, a large number of primary particles having secured conductivity are present in the secondary particles. As a result, cycle characteristics (i.e., the ability of maintaining initial battery capacity after charge and discharge cycles) can be improved, as compared to the case where a small number of primary particles are present at the surfaces of the secondary particles.

### Effects of the Invention

With the structure of the present invention, a lithium composite oxide containing Ni is more effectively utilized as a positive electrode active material and a nonaqueous electrolyte secondary battery exhibiting improved power characteristics and cycle characteristics is provided.

### BRIEF DESCRIPTION OF DRAWINGS

FIG. 1 is a view schematically illustrating a reactor for synthesizing composite hydroxides which are constituents of a positive electrode active material.

FIG. 2 is a scanning electron microscope photograph of the surface of a positive electrode active material according to the present invention.

FIG. 3 is a scanning electron microscope photograph of a cross section of the positive electrode active material according to the present invention.

FIG. 4 is a scanning electron microscope photograph of the surface of a conventional positive electrode active material.

FIG. 5 is a scanning electron microscope photograph of a cross section of the conventional positive electrode active material.

### DESCRIPTION OF NUMERALS

1 reactor
2 tube
3 stirring rod
4, 5, 6, 7, 8 pump
9, 10, 11 pipe

### BEST MODE FOR CARRYING OUT THE INVENTION

Prior to description of a preferred embodiment, studies of the inventors of this invention are now described.

The inventors prepared two types of Co-based materials and two types of Ni-based materials to examine power characteristics thereof. In this examination, each two types of positive electrode active materials had the same particle size of secondary particles and had different exposure ratios. The “exposure ratio” herein means that in cross sections of the secondary particles each passing through substantially the center thereof, the cross-sectional area of primary particles at least partially exposed at the surfaces of secondary particles with respect to the cross-sectional area of all the primary particles constituting the secondary particles. In the following description, one of the two positive electrode active materials having a higher exposure ratio is referred to as a positive electrode active material L and the other having a lower exposure ratio is referred to as a positive electrode active material S.

The examination of power characteristics showed that no differences were observed between the Co-based materials but the positive electrode active material L was more excellent than the positive electrode active material S for the Ni-based materials. In other words, it was shown that in the Ni-based materials, lithium ions moved to/from a nonaqueous electrolyte at a higher speed in the positive electrode active material L than in the positive electrode active material S.

In general, a positive electrode active material is formed of secondary particles each constituted by aggregated primary particles. The primary particles have no particle boundaries whereas each secondary particle has one or more particle boundaries. In primary particles constituting a secondary particle and at least partially exposed at the surface of the secondary particle, lithium ions move within these primary particles and are directly exchanged between these primary particles and a nonaqueous electrolyte. Accordingly, when the speed of lithium ions moving in the primary particles is increased, the speed of exchanging lithium ions is increased. On the other hand, in primary particles constituting the secondary particle and not exposed at the surface of the secondary particle, lithium ions are not directly exchanged between these primary particles and the nonaqueous electrolyte in many cases and are exchanged through repetition of movement within the primary particles and movement across particle boundaries.

Since the exposure ratio of the positive electrode active material L is higher than that of the positive electrode active material S as described above, lithium ions are directly exchanged between the positive electrode active material L and the nonaqueous electrolyte only through movement within primary particles therein in many cases. On the other hand, in the positive electrode active material S, lithium ions are exchanged with the nonaqueous electrolyte through repetition of movement within primary particles and movement across particle boundaries. In other words, the speed of movement of lithium ions depends on the speed of movement within primary particles in the positive electrode active material L, whereas the movement across particle boundaries determines the rate when (the speed of movement within primary particles)>(the speed of movement across particle boundaries) and movement within primary particles determines the rate when (the speed of movement within primary particles)<(the speed of movement across particle boundaries) in the positive electrode active material S.

Examination was also conducted on Mn-based materials. However, even when the speed of movement of lithium ions across particle boundaries is increased by increasing the exposure ratio in the Mn-based materials, poor conductivity of the Mn-based materials makes increase of power difficult.

The experimental results on Co-based and Ni-based materials are now discussed in consideration of the foregoing findings. With respect to the Co-based materials, power characteristics did not considerably differ between the positive electrode active material L and the positive electrode active material S, and thus it is considered that movement within primary particles determined the rate. On the other hand, with respect to the Ni-based materials, the positive electrode active material L exhibited more excellent power characteristics than the positive electrode active material S, and thus it is considered that the speed of movement across particle boundaries determined the rate.

The inventors found, for the first time, that the rate-determining step of movement of lithium ions differs between Ni-based materials and Co-based materials, and completed this invention in consideration that (the speed of movement within primary particles)>(the speed of movement across particle boundaries) in the Ni-based materials. Hereinafter, an embodiment of the present invention will be specifically described with reference to the drawings.

In this embodiment, a positive electrode active material is a positive electrode active material for a nonaqueous electrolyte secondary battery, contains Ni, and is formed of secondary particles each constituted by aggregated primary particles. In cross sections of the secondary particles of the positive electrode active material, the total cross-sectional area of primary particles at least partially exposed at the surfaces of the secondary particles is 40% or more of the total cross-sectional area of all the primary particles constituting the secondary particles. In other words, in the positive electrode active material of this embodiment, the exposure ratio is 40% or more.

In such a positive electrode active material, a large number of primary particles are exposed at the surfaces of the secondary particles and, therefore, are in contact with a nonaqueous electrolyte. As a result, power characteristics of a nonaqueous electrolyte secondary battery are improved.

Specifically, as described above, it is considered that (the speed of movement within primary particles)>(the speed of movement across particle boundaries) in a Ni-based material. However, in the positive electrode active material of this embodiment, most of the primary particles constituting the secondary particles directly exchange lithium ions with the nonaqueous electrolyte so that lithium ions move between the primary particles and the nonaqueous electrolyte without passing across particle boundaries. Accordingly, the positive electrode active material of this embodiment achieves improved power characteristics of a nonaqueous electrolyte secondary battery, as compared to a conventional Ni-based material.

In addition, in the positive electrode active material of this embodiment, most of the primary particles constituting the secondary particles are exposed at the surfaces of the secondary particles. Thus, most of the primary particles constituting the secondary particles are coated with a conductive agent. Accordingly, even when each secondary particle is split into a plurality of primary particles during charge and discharge cycles, coating of the surfaces of these primary particles with the conductive agent suppresses a decrease in capacity. As a result, cycle characteristics are improved.

Examples of a method for measuring the number of primary particles in a cross section of a secondary particle include a method of cutting a secondary particle with a focused ion beam (FIB), obtaining an image of the cross section with a scanning electron microscope, and measuring the number of primary particles exposed at the surface of the secondary particle on the image. As another method, a large number of secondary particles are observed with a scanning electron microscope so that the average particle size thereof is obtained, and then these secondary particles are filled with a resin and the cut-out section of this resin is polished and observed with a scanning electron microscope. With this method, the amount of primary particles in a cross section taken at substantially the center of the secondary particle is also measured.

As a method for obtaining an exposure ratio, primary particles exposed at the surfaces of secondary particles are observed with one of the foregoing methods, and the total cross-sectional area of these primary particles is calculated. Then, the average particle size of the secondary particles is obtained with a scanning electron microscope photograph and the cross-sectional area of the secondary particles is calculated. Thereafter, the total cross-sectional area of the primary particles with respect to the cross-sectional area of the secondary particles is calculated, thereby obtaining an exposure ratio.

In the positive electrode active material of this embodiment, the exposure ratio is preferably 60% or more in cross sections of the secondary particles.

When the exposure ratio is 60% or more, a larger number of primary particles are exposed at the surfaces of the secondary particles than the case where the exposure ratio is 40% or more. Accordingly, power characteristics and cycle life characteristics of a nonaqueous electrolyte secondary battery are improved, as compared to the case where the exposure ratio is 40% or more.

In addition, in the positive electrode active material of this embodiment, it is preferable that in cross sections of the secondary particles, the exposure ratio is 40% or more and that the ratio of average length of primary particles along their longitudinal axes with respect to the average particle size of secondary particles is 0.2 or more.

In such a positive electrode active material, a larger number of primary particles are exposed at the surfaces of secondary particles. In addition, since the size of primary particles is large in the positive electrode active material of this embodiment, even when each secondary particle is divided into a plurality of primary particles through repeated charge and discharge cycles as described above, the speed of elution of metal elements from the primary particles to a nonaqueous electrolyte is lower than that in the case where the size of primary particles is small. Accordingly, even when each secondary particle is divided into primary particles, decrease in capacity of a positive electrode is suppressed.

The reason why the average length of primary particles along their short axes is not measured but the average length of primary particles along their longitudinal axes is measured is now explained. If two types of primary particles, such as spherical primary particles and slender primary particles, having the same volume but different in shape are used to respectively form secondary particles having the same size, the number of primary particles exposed at surfaces of the secondary particles is larger in the case of using the slender primary particles than that in the case of using the spherical primary particles. In addition, the average length of primary particles along their longitudinal axes can be estimated by observing the cross sections of the secondary particles with a scanning electron microscope photograph, measuring the length of each primary particle along the longitudinal axis, and calculating the average length of the primary particles.

In addition, in the positive electrode active material of this embodiment, it is preferable that the exposure ratio is 40% or more and that Ni and Mn having substantially the same mole fraction are contained.

If the positive electrode active material contains Ni and Mn having substantially the same mole fraction as described above, Ni and Mn are mixed together at a ratio of 1:1 at an atomic level as disclosed in Patent Document 1, thereby causing an interaction between the electron structure of Ni and the electron structure of Mn. As a result, conductivity of the positive electrode active material is enhanced so that power characteristics and cycle characteristics are improved.

The improvement of cycle characteristics is considered to be due to the fact that the mixture of Ni and Mn at an atomic level stabilizes the crystal structure of the positive electrode active material so that elution of Mn from the positive electrode active material is suppressed.

The reason why the mixture of Ni and Mn at a ratio of 1:1 at an atomic level stabilizes the crystal structure of the positive electrode active material is considered to be as follows.

When Ni and Mn are dissolved at an atomic level, the electron structures of different elements in close proximity to each other interact with each other and change. This change of the electron structures causes characteristics of each element to change. Specifically, the manganese element is generally easily soluble in a nonaqueous electrolyte secondary battery. For example, when a compound such as LiMn₂O₄ or LiMnO₂ is used as a positive electrode active material, Mn is eluted from the positive electrode active material to be deposited on the negative electrode in some cases. In such cases, the life of the battery is shortened. However, it is considered that the presence of nickel elements near these manganese elements changes the electron state of the manganese elements to suppress elution of the manganese elements into the nonaqueous electrolyte and, thereby, to stabilize the crystal structure. This phenomenon is also observed in, for example, nickel-metal hydride batteries. The negative electrode of the nickel-metal hydride battery is formed by using a hydrogen-absorbing alloy containing Al or Mn. This element of Al or Mn is solely soluble in an alkaline electrolyte. However, in the hydrogen-absorbing alloy, Al or Mn is dissolved with metal elements such as Ni at an atomic level so that the speed of dissolving Al or Mn in the alkaline electrolyte is greatly reduced.

For the foregoing reasons, the positive electrode active material preferably contains Ni and Mn having substantially the same mole fraction.

In addition, in the positive electrode active material of this embodiment, it is preferable that the exposure ratio is 40% or more, the mole fractions of Ni and Mn are substantially the same, the crystal structure thereof is a rhombohedral structure, the length along the c axis of a hexagonal structure as which the crystal structure is approximated is 14.2 Å or more, and the total amount of Ni and Mn is 60 mol % or more of the amount of all the metal elements forming the positive electrode active material. In such a positive electrode active material, power characteristics and cycle characteristics are further improved.

This is because when the positive electrode active material contains 60 mol % or more of Ni and Mn having substantially the same mole fraction as metal elements, the order (crystallinity) of crystal structure of the positive electrode active material is improved and, therefore, a distance of 14.2 Å or more between layers in this crystal structure allows the speed of movement of lithium ions within the crystal (i.e., the speed of movement of lithium ions within primary particles) to be sufficiently high. It is considered that when the speed of movement of lithium ions within the crystal is sufficiently high, the speed of movement of lithium ions depends on the speed of movement across particle boundaries. Therefore, in such a positive electrode active material, the advantages obtained by increasing the exposure ratio are considerably apparent. In the positive electrode active material, it is unpreferable that the total amount of Ni and Mn is less than 60 mol % of the amount of all the metal elements because of the following reason. If the total amount of Ni and Mn is less than 60 mol %, the amount of the other elements increases. Thus, preferable electron structures of Ni and Mn cannot be maintained even when the mole fraction ratio between Ni and Mn is 1:1.

Specifically, if the total amount of Ni and Mn is less than 60 mol %, the order of the crystal structure cannot be maintained in spite of an exposure ratio of 40% or more in some cases. Further, if the distance between layers in the crystal structure is less than 14.2 Å, the diffusion speed of lithium ions within crystal layers cannot be sufficiently high in spite of an exposure ratio of 40% or more in some cases. Accordingly, it is considered that the speed of movement of lithium ions cannot be increased even by increasing the exposure ratio so that it is difficult to improve power characteristics in some cases.

Moreover, in the positive electrode active material of this embodiment, it is preferable that the exposure ratio is 40% or more, Ni and Co are contained, the crystal structure thereof is a rhombohedral structure, the length along the c axis of a hexagonal structure as which the crystal structure is approximated is 14.13 Å or more, and the Ni content is 55 mol % or more of the amount of all the metal elements. In such a positive electrode active material, power characteristics and cycle characteristics are further improved.

This is because when the positive electrode active material contains 55 mol % or more of Ni, the order of crystal structure of the positive electrode active material is improved and a distance of 14.13 Å or more between layers in this crystal structure allows the speed of movement of lithium ions within the crystal to be sufficiently high. It is considered that when the speed of diffusion of lithium ions within the crystal is sufficiently high, the speed of movement of lithium ions in the positive electrode active material depends on the speed of movement across particle boundaries. Therefore, in such a positive electrode active material, the advantages obtained by increasing the exposure ratio are considerably apparent.

Specifically, if the Ni content is less than 55%, the order of crystal structure of the positive electrode active material cannot maintained in spite of an exposure ratio of 40% or more in some cases. Further, if the distance between layers is less than 14.13 Å, the diffusion speed of lithium ions within the crystal cannot be sufficiently high in spite of an exposure ratio of 40% or more in some cases. Accordingly, it is considered that the speed of movement of lithium ions cannot be increased even by increasing the exposure ratio so that it is difficult to improve power characteristics in some cases.

The positive electrode active material described above can be formed by one of the following methods.

A method for synthesizing a positive electrode active material is generally to bake a metal hydroxide to generate a metal oxide and then bake the metal oxide again with lithium salt added thereto. To synthesize a positive electrode active material having a large primary particle size, it is preferable to use a metal hydroxide having a large primary particle size. That is, a first synthesis method is to synthesize a positive electrode active material using a metal hydroxide having a large primary particle size.

A second synthesis method is to optimize the composition of a material such as a metal oxide or lithium salt or to optimize baking conditions such as baking temperature or baking time. In examples which will be described below, the positive electrode active material of this embodiment is synthesized with the second synthesis method.

Fabrication of a nonaqueous electrolyte secondary battery (specifically, a lithium ion secondary battery) using one of the foregoing positive electrode active materials achieves excellent power characteristics and cycle characteristics of the battery. As a method for fabricating a nonaqueous electrolyte secondary battery, a known method can be employed.

In this embodiment, a nonaqueous electrolyte is used as an example of an electrolyte. Alternatively, a gelled nonaqueous electrolyte may be used. In such a case, the same advantages are, of course, also obtained.

### EXAMPLES

### Example 1

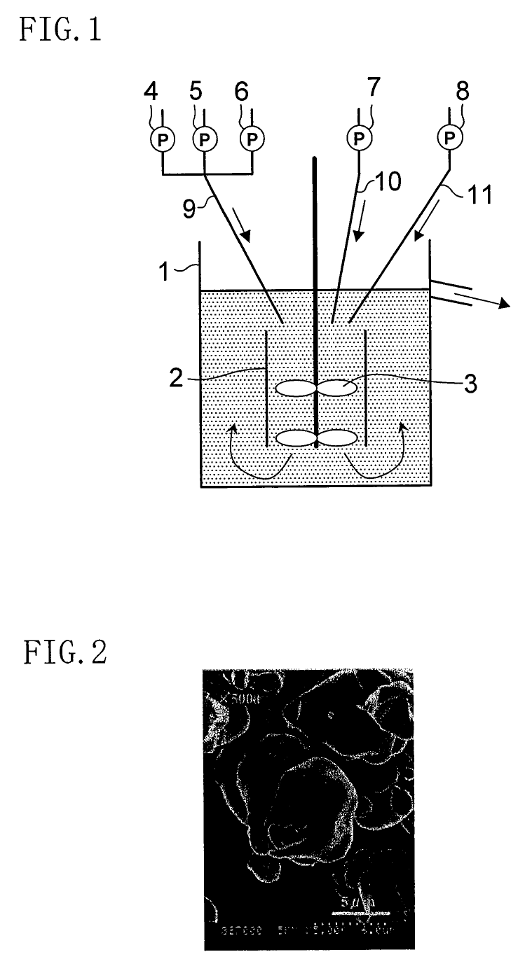

FIG. 1 schematically illustrates manufacturing apparatus for synthesizing hydroxides (i.e., constituents of a positive electrode active material). As the constituents, 1 mol/L of a nickel sulfate aqueous solution, 1 mol/L of a manganese sulfate aqueous solution, 1 mol/L of a cobalt sulfate aqueous solution, 5 mol/L of an ammonium aqueous solution, and 5 mol/L of a sodium hydroxide aqueous solution were continuously supplied to a reactor 1 while being stirred with the flow rates thereof controlled with pumps 4 through 8 such that the composition of a composite hydroxide to be produced was obtained. The pumps 4 through 6 supplied the sulfate aqueous solutions containing metal elements, the pump 7 supplied the sodium hydroxide aqueous solution, and the pump 8 supplied the ammonium aqueous solution.

The manufacturing apparatus is now described. The manufacturing apparatus includes pipes 9 through 11 for supplying the above-mentioned solutions from the pumps 4 through 8 to the reactor 1. The sulfate aqueous solutions containing the three metal elements described above were mixed together to be uniform before being supplied to the reactor 1.

A cylindrical tube 2 is provided in the reactor 1 and a stirring rod 3 is inserted in the tube 2. Fine particles of a composite hydroxide were produced in this tube 2. However, a downward force was applied to the fine particles of the composite hydroxide by the stirring rod 3 so that the fine particles collided against each other and were grown to be aggregated particles. These particles of the composite hydroxide overflowed the tube 2 as indicated by the arrows in FIG. 1 to be taken to the outside the manufacturing apparatus. At this time, only a small number of particles circulated the tube 2 once and then overflowed the tube 2, and most of the fine particles circulated in the reactor 1 multiple times to be grown and became large. The temperature of the reactor 1 was kept at 30° C. to 50° C.

Various types of composite hydroxides having different compositions were prepared by changing the flow rate of the metal salt aqueous solutions, the ammonium aqueous solution, or the sodium hydroxide aqueous solution or by changing the temperature of the reactor or the stirring speed of the stirring rod 3.

Next, these composite hydroxides were rinsed with water, dried, and then baked in the atmosphere, thereby producing composite oxides.

Thereafter, each of these composite oxides was mixed with lithium carbonate in such a manner that the number of moles of Li was equal to the number of moles of metal elements in the composite oxide. Then, the mixture was baked at 1100° C. in the atmosphere. Subsequently, the baked composite oxide was mixed with lithium carbonate in an amount corresponding to evaporated Li, and the mixture was baked at 1000° C. again. By changing the temperature and time of this baking, the amount of primary particles exposed at the surfaces of secondary particles was adjusted.

In this manner, positive electrode active materials 1a through 1aa containing Ni and Mn were obtained. Thereafter, the total cross-sectional area of primary particles exposed at the surfaces of secondary particles was obtained. Specifically, first, a large number of secondary particles were observed with a particle size distribution analyzer and a scanning electron microscope. Then, the average particle size of the secondary particles was measured with a scanning electron microscope photograph. Subsequently, the secondary particles were filled with a resin and the cut-out section of this resin was polished and observed with a scanning electron microscope. In this manner, primary particles at least partially exposed at the surfaces of the secondary particles were observed in a cross section taken at substantially the center of each secondary particle. Then, the total cross-sectional area of the primary particles at least partially exposed at the surfaces of the secondary particles was obtained.

Subsequently, the total cross-sectional area of primary particles constituting the secondary particles was obtained so that the ratio (exposure ratio) between this total cross-sectional area and the cross-sectional area of primary particles at least partially exposed at the surfaces of the secondary particles was calculated. The average length of the primary particles along their longitudinal axes was also measured with a cross-sectional photograph of secondary particles taken with a scanning electron microscope. Each of the average particle size of the secondary particles and the average length of the primary particles along their longitudinal axes was obtained by performing image processing on a scanning electron microscope photograph with “Particle Size Distribution Analysis Software MAC-View Ver. 3.5” produced by Mountech. Co., Ltd.

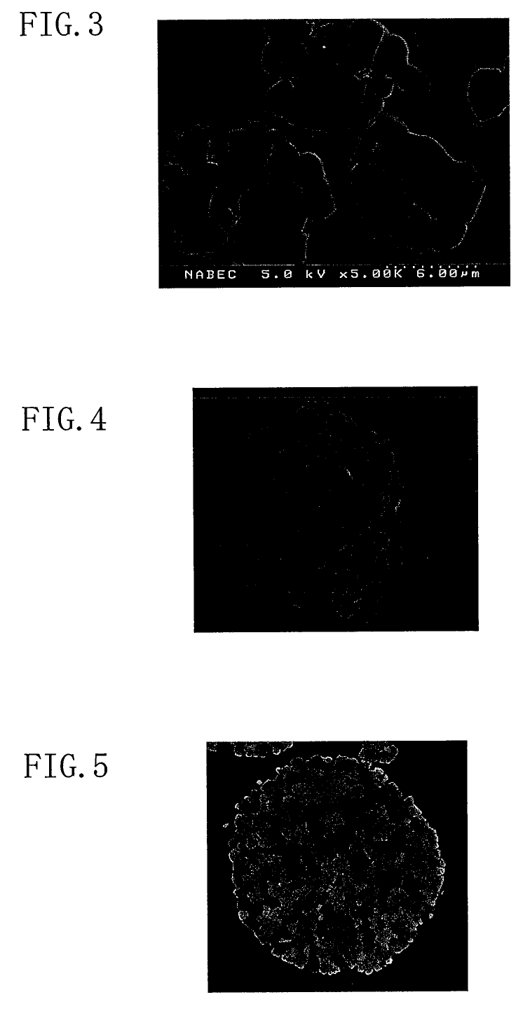

As an example, FIG. 2 shows a scanning electron microscope photograph of the surface of an active material 1u having a composition of Ni:Mn:Co=33:33:33. FIG. 3 shows a scanning electron microscope photograph of a cut-out section of the active material 1u which is filled with a resin. To obtain the average particle size of secondary particles and the average length of primary particles along their longitudinal axes, image processing was performed on photographs in a field of view wider than those of the photographs shown in FIGS. 2 and 3. The secondary particles are large clusters in FIG. 3 and the primary particles are small particles constituting these large clusters.

From these results, it was confirmed that the exposure ratio was 85% in the positive electrode active material 1u. It was also found that the average particle size of the secondary particles was 11 μm and the average length of the primary particles along their longitudinal axes was 4.3 μm.

In addition, an X-ray diffraction analysis was performed on the positive electrode active material 1u. With the obtained diffraction pattern, it was confirmed that the crystal structure of this active material was a rhombohedral structure and the length along the c axis of a hexagonal structure as which the crystal structure of the positive electrode active material was approximated was measured.

In the same manner, for the other active materials, the exposure ratio (“primary particle amount (%) at surface” in Table 1), the average particle size of secondary particles (“average particle size (μm)” in Table 1), the average length of primary particles along their longitudinal axes (“longitudinal axis” in Table 1), the ratio of average length of primary particles along their longitudinal axes with respect to the average particle size of secondary particles (“ratio” in Table 1), and the length along the c axis of a hexagonal structure as which the crystal structure of the positive electrode active material was approximated (“c axis (Å)” in Table 1) were obtained. These results are shown in Table 1. It was confirmed that the crystal structures of all the positive electrode active materials were rhombohedral structures.

TABLE 1

| | | | | | | average | | | | | | |
|---|---|---|---|---|---|---|---|---|---|---|---|---|
| | | mole | | | primary particle | particle | longitudinal | | | | | number |
| | active | fraction % | | | amount % at surface | size | axis | | c axis | | power | of |
| | material | Ni | Mn | Co | % | μm | μm | ratio | Å | battery | % | cycles |
| comparative | 1ab | 26 | 26 | 48 | 16 | 10 | 1.2 | 0.12 | 14.10 | 1AB | 95 | 90 |
| example 1 | 1ac | 30 | 30 | 40 | 15 | 10 | 1.0 | 0.10 | 14.20 | 1AC | 97 | 90 |
| | 1ad | 33 | 33 | 33 | 15 | 10 | 1.0 | 0.10 | 14.25 | 1AD | 100 | 90 |
| | 1ae | 40 | 40 | 20 | 15 | 8 | 0.9 | 0.11 | 14.28 | 1AE | 102 | 80 |
| | 1af | 50 | 50 | | 14 | 8.5 | 0.8 | 0.09 | 14.30 | 1AF | 96 | 80 |
| | 1ag | 55 | 45 | | 15 | 9 | 1.0 | 0.11 | 14.29 | 1AG | 97 | 80 |
| | 1ah | 45 | 55 | | 14 | 8 | 0.8 | 0.10 | 14.31 | 1AH | 95 | 70 |
| | 1ai | 30 | 50 | 20 | 14 | 10 | 1.0 | 0.10 | 14.26 | 1AI | 94 | 70 |
| | 1aj | 50 | 30 | 20 | 15 | 10 | 1.1 | 0.11 | 14.24 | 1AJ | 104 | 90 |
| comparative | 1ak | 26 | 26 | 48 | 28 | 10 | 1.7 | 0.17 | 14.10 | 1AK | 96 | 100 |
| example 2 | 1al | 30 | 30 | 40 | 30 | 10.5 | 2.0 | 0.19 | 14.20 | 1AL | 98 | 100 |
| | 1am | 33 | 33 | 33 | 31 | 11 | 1.8 | 0.16 | 14.25 | 1AM | 103 | 100 |
| | 1an | 40 | 40 | 20 | 33 | 8.5 | 1.6 | 0.19 | 14.28 | 1AN | 104 | 90 |
| | 1ao | 50 | 50 | | 26 | 9 | 1.5 | 0.17 | 14.30 | 1AO | 98 | 90 |
| | 1ap | 55 | 45 | | 30 | 10 | 1.6 | 0.16 | 14.29 | 1AP | 98 | 90 |
| | 1aq | 45 | 55 | | 25 | 9 | 1.5 | 0.17 | 14.31 | 1AQ | 97 | 80 |
| | 1ar | 30 | 50 | 20 | 25 | 10 | 1.5 | 0.15 | 14.26 | 1AR | 95 | 80 |
| | 1as | 50 | 30 | 20 | 30 | 9 | 1.7 | 0.19 | 14.24 | 1AS | 105 | 100 |
| example 1 | 1a | 26 | 26 | 48 | 41 | 10.5 | 2.5 | 0.24 | 14.10 | 1A | 105 | 140 |
| | 1b | 30 | 30 | 40 | 40 | 10 | 2.0 | 0.20 | 14.20 | 1B | 125 | 160 |
| | 1c | 33 | 33 | 33 | 43 | 11 | 2.5 | 0.23 | 14.25 | 1C | 128 | 160 |
| | 1d | 40 | 40 | 20 | 40 | 9 | 2.1 | 0.23 | 14.28 | 1D | 130 | 160 |
| | 1e | 50 | 50 | | 42 | 9 | 2.4 | 0.27 | 14.30 | 1E | 128 | 150 |
| | 1f | 55 | 45 | | 43 | 10 | 2.4 | 0.24 | 14.29 | 1F | 130 | 150 |
| | 1g | 45 | 55 | | 40 | 9 | 2.4 | 0.27 | 14.31 | 1G | 127 | 140 |
| | 1h | 30 | 50 | 20 | 40 | 10 | 2.0 | 0.20 | 14.26 | 1H | 102 | 100 |
| | 1i | 50 | 30 | 20 | 40 | 9.5 | 2.0 | 0.21 | 14.24 | 1I | 114 | 120 |
| | 1j | 26 | 26 | 48 | 60 | 10 | 3.3 | 0.33 | 14.10 | 1J | 110 | 180 |
| | 1k | 30 | 30 | 40 | 61 | 11 | 3.6 | 0.33 | 14.20 | 1K | 140 | 200 |
| | 1l | 33 | 33 | 33 | 60 | 11 | 3.8 | 0.35 | 14.25 | 1L | 145 | 200 |
| | 1m | 40 | 40 | 20 | 62 | 9 | 3.0 | 0.33 | 14.28 | 1M | 148 | 190 |
| | 1n | 50 | 50 | | 64 | 9 | 3.0 | 0.30 | 14.30 | 1N | 144 | 180 |
| | 1o | 55 | 45 | | 66 | 10 | 3.1 | 0.31 | 14.29 | 1O | 145 | 180 |
| | 1p | 45 | 55 | | 60 | 9 | 3.0 | 0.33 | 14.31 | 1P | 143 | 170 |
| | 1q | 30 | 50 | 20 | 62 | 10 | 3.0 | 0.30 | 14.26 | 1Q | 114 | 130 |
| | 1r | 50 | 30 | 20 | 65 | 9 | 2.8 | 0.31 | 14.24 | 1R | 125 | 150 |
| | 1s | 26 | 26 | 48 | 80 | 10.5 | 4.0 | 0.38 | 14.10 | 1S | 110 | 180 |
| | 1t | 30 | 30 | 40 | 82 | 11 | 4.0 | 0.36 | 14.20 | 1T | 138 | 210 |
| | 1u | 33 | 33 | 33 | 85 | 11 | 4.3 | 0.39 | 14.25 | 1U | 145 | 200 |
| | 1v | 40 | 40 | 20 | 90 | 9 | 4.0 | 0.44 | 14.28 | 1V | 148 | 180 |
| | 1w | 50 | 50 | | 85 | 9 | 3.5 | 0.39 | 14.30 | 1W | 142 | 180 |
| | 1x | 55 | 45 | | 88 | 10 | 3.8 | 0.38 | 14.29 | 1X | 143 | 180 |
| | 1y | 45 | 55 | | 80 | 9 | 3.5 | 0.39 | 14.31 | 1Y | 140 | 170 |
| | 1z | 30 | 50 | 20 | 87 | 9.5 | 3.5 | 0.37 | 14.26 | 1Z | 112 | 130 |
| | 1aa | 50 | 30 | 20 | 84 | 9 | 3.0 | 0.33 | 14.24 | 1AA | 120 | 140 |

### Comparative Example 1

In the same manner as in Example 1, various composite oxides were prepared. Each of these composite oxides was mixed with lithium carbonate in such a manner that the number of moles of Li was equal to the number of moles of metal elements in the composite oxide. Then, the mixture was baked at 950° C. in the atmosphere, and then was baked at 750° C. again.

In this manner, positive electrode active materials 1ab through 1aj were prepared. In these positive electrode active materials, primary particles were not sufficiently grown and secondary particles were clusters of very fine primary particles as disclosed in, for example, Patent Document 1.

As an example, FIG. 4 shows a scanning electron microscope photograph of the surface of the active material 1ad having a composition of Ni:Mn:Co=33:33:33. FIG. 10 shows a scanning electron microscope photograph of a cut-out section of the active material 1ad which is filled with a resin. The primary particles had an average particle size of about 1 μm and constituted large clusters as shown in FIG. 5. The secondary particles were each constituted by a large number of such primary particles, were large clusters as shown in FIG. 5, and had an average particle size of 10 μm.

In the same manner as in Example 1, the exposure ratio, the average particle size of the secondary particles, the average length of the primary particles along their longitudinal axes, the ratio of average length of the primary particles along their longitudinal axes with respect to the average particle size of the secondary particles, and the length along the c axis of a hexagonal structure as which the crystal structure of the positive electrode active material was approximated were obtained. The results are shown in Table 1.

### Comparative Example 2

In the same manner as in Example 1, various composite oxides were prepared. Each of these composite oxides was mixed with lithium carbonate in such a manner that the number of moles of Li was equal to the number of moles of metal elements in the composite oxide. Then, the mixture was baked at 1000° C. in the atmosphere. Subsequently, the baked composite oxide was mixed with lithium carbonate in an amount corresponding to evaporated Li, and the mixture was baked at 1000° C. again. By changing the temperature and time of this baking, the number of primary particles exposed at the surfaces of secondary particles was adjusted. In this manner, positive electrode active materials 1ak through 1as were prepared.

In the same manner as in Example 1, the exposure ratio, the average particle size of the secondary particles, the average length of the primary particles along their longitudinal axes, the ratio of average length of the primary particles along their longitudinal axes with respect to the average particle size of the secondary particles, and the length along the c axis of a hexagonal structure as which the crystal structure of the positive electrode active material was approximated were obtained. The results are shown in Table 1.

Then, using the positive electrode active materials (1a through 1aa) produced in Example 1, the positive electrode active materials (1ab through 1aj) produced in Comparative Example 1, and the positive electrode active materials (1ak through 1as) produced in Comparative Example 2, nonaqueous electrolyte secondary batteries 1A through 1AS were prepared in the following manner.

First, 100 parts by weight of positive electrode active material powder, 2.5 parts by weight of acetylene black as a conductive agent, 4 parts by weight of polyvinylidine difluoride (PVDF) as a binder, and a dispersion medium were kneaded, thereby preparing positive electrode slurry. Subsequently, the positive electrode slurry was applied onto both faces of aluminum foil (a current collector) having a thickness of 15 μm and then was dried. Thereafter, the slurry was rolled to a uniform thickness with a rolling press, and the current collector was cut to have a width of 50 mm, thereby forming a positive electrode. The application of the positive electrode slurry to the current collector was performed in such a manner that the current collector was partially exposed.

Next, 100 parts by weight of graphite as a negative electrode active material, a 6 parts by weight of PVDF as a binder, and a dispersion medium were kneaded, thereby preparing negative electrode slurry. Thereafter, the negative electrode slurry was applied onto both faces of copper foil (a current collector) having a thickness of 10 μm, and then was dried and rolled. Subsequently, the current collector was cut to have a width of 52 mm, thereby forming a negative electrode. The application of the negative electrode slurry to the current collector was performed in such a manner that the current collector was partially exposed.

Subsequently, current collecting leads were welded to respective portions of the positive and negative electrodes where the current collectors were exposed. Then, a polyethylene separator with a thickness of 27 μm was interposed between the positive and negative electrodes and was wound in a spiral, thereby obtaining an electrode group. The electrode group was placed in a stainless battery can in the shape of a bottomed cylinder. Thereafter, a nonaqueous electrolyte was poured into the battery can, thereby preparing nonaqueous electrolyte secondary batteries 1A through 1AS. The battery can had a thickness of 25 μm, an outside diameter of 18 mm, and a height of 65 mm. As the nonaqueous electrolyte, a material obtained by dissolving 1M of LiPF₆ in a solvent in which ethylene carbonate (EC) and ethyl methyl carbonate (EMC) were mixed at a volume ratio of 1:3 was used.

Each of these nonaqueous electrolyte secondary batteries 1A through 1AS was aged for seven days in an atmosphere of 450° C. in a state of being charged to 4.1 V at 0.4 A. Then, the battery was discharged to 3.0 V in an atmosphere of 25° C., and then charged to 4.2 V at a constant current of 0.4 A. Thereafter, charging was performed at a constant voltage of 4.2 V until the current reached 0.2 A. After having been left alone for 30 minutes, the battery was discharged to 3 V at 0.4 A. The battery capacity of each of the nonaqueous electrolyte secondary batteries 1A through 1AS was 1.2 Ah.

Thereafter, each of the batteries was charged to 4.2 V at a constant current of 0.4 A in an atmosphere of 25° C., and then was charged at a constant voltage of 4.2 V until current reached 0.2 A. Subsequently, the battery was left alone for two hours in an atmosphere of 0° C., and then was discharged at a current of 3 A for 10 seconds. The difference (voltage difference) in open-circuit voltage between before and after charging at 3 A for 10 seconds was obtained.

This voltage difference includes not only a voltage difference caused by the positive electrode active material but also a voltage difference due to the resistance of members of the batteries. The member resistances can be greatly reduced by, for example, tab-less current collection. To determine the voltage difference caused by the positive electrode active material, a net voltage difference was obtained by subtracting a voltage difference due to, for example, the member resistance from the voltage difference described above. The AC resistance at 1 kHz for each battery was defined as the member resistance. Since the reciprocal of the net voltage difference is proportional to the power of the nonaqueous electrolyte secondary battery, this reciprocal was used as an index of the power. In Table, 1, the value of power of the nonaqueous electrolyte secondary battery 1AD is shown as 100.

Then, cycle characteristics were examined by performing the following charge and discharge cycles. Specifically, each battery was charged to 4.2 V at a constant current of 1 A in an atmosphere of 45° C., and then was charged at a constant voltage of 4.2 V until the current reached 0.2 A. After having been left alone for 30 minutes, the battery was discharged to 3 V at 1 A. Table 1 indicates the number of cycles when the battery capacity becomes less than 60% of the initial battery capacity.

Experimental results are now discussed by comparing the results on the nonaqueous electrolyte secondary batteries 1A through 1AA of Example 1 and the results on the nonaqueous electrolyte secondary batteries 1AB through 1AS of Comparative Examples 1 and 2.

As shown in Table 1, the nonaqueous electrolyte secondary batteries 1A through 1AA exhibited higher exposure ratios and more excellent power characteristics and cycle characteristics than the nonaqueous electrolyte secondary batteries 1AB through 1AS of Comparative Examples.

Specifically, when the exposure ratio was less than 40%, it was difficult to improve power characteristics and cycle life characteristics, irrespective of the compositions of the positive electrode active materials. On the other hand, when the exposure ratio was 40% or more, power characteristics and cycle characteristics were improved.

The reason of improvement of power characteristics with an exposure ratio of 40% or more is considered that a large number of primary particles were exposed at the surfaces of secondary particles so that lithium ions were allowed to be exchanged without passing across particle boundaries between primary particles. When the exposure ratio was 40% or more, advantages obtained by increasing the exposure ratio were considerably apparent.

The improvement of cycle characteristics with an exposure ratio of 40% or more is considered to be because of the following reasons. As a first reason, a large number of primary particles are exposed at the surfaces of secondary particles with an exposure ratio of 40% or more and conductivity is secured at the surfaces of the secondary particles. Accordingly, even when the secondary particles are cracked through the expansion and contraction caused by charging and discharging operation, conductivity of a large number of primary particles is secured. As a second reason, since the positive electrode active materials of Example 1 have a larger primary particle size and, therefore, have a smaller specific surface area thereof than the positive electrode active materials of Comparative Examples 1 and 2, the speed of elution of a metal such as Mn at the surfaces of primary particles is reduced even when each secondary particle is divided into a plurality of primary particles. As a third reason, improvement of power characteristics suppresses temperature rise of the battery in charge and discharge cycles, resulting in reduction of elution speed of a metal element such as Mn.

The reason why the comparison is performed using the positive electrode active materials having the same composition is because power characteristics and cycle characteristics vary depending on the compositions of the positive electrode active materials.

The results on the nonaqueous electrolyte secondary batteries 1A through 1AA of Example 1 are further discussed.

The nonaqueous electrolyte secondary batteries 1J through 1AA using the positive electrode active materials 1j through 1aa exhibited improved power characteristics and cycle characteristics, as compared to the nonaqueous electrolyte secondary batteries 1A through 1I using the positive electrode active materials 1a through 1i. Since the exposure ratio was 60% or more in the positive electrode active materials 1j through 1aa, the foregoing advantages were more apparent than in the case where the exposure ratio was 40% or more and less than 60%.

The power characteristics and cycle characteristics were not significantly different between the case where the exposure ratio was 60% or more and less than 80% (i.e., the positive electrode active materials 1j through 1r) and the case where the exposure ratio was 80% or more (i.e., the positive electrode active materials 1s through 1aa). This is considered to be because the size of primary particles was larger in the case of an exposure ratio of 80% or more and, thus, the specific surface area thereof was smaller, resulting in canceling advantages obtained by increasing the exposure ratio. Specifically, when the exposure ratio is less than 40%, a large number of particle boundaries exist so that lithium ions slowly move between the active material and the nonaqueous electrolyte. On the other hand, when the exposure ratio exceeds 80%, the specific surface area is small so that the contact area between the primary particles and the nonaqueous electrolyte is small, thus reducing the reaction speed. In view of this, it is sufficient that the exposure ratio is 40% or more. The exposure ratio is preferably in the range from 40% to 100%, both inclusive, and more preferably in the range from 60% to 100%, both inclusive, and most preferably in the range from 60% to 80%, both inclusive. When the exposure ratio is 100%, all the primary particles constituting secondary particles are exposed at the surfaces of the secondary particles.

Among the nonaqueous electrolyte secondary batteries 1A through 1AA, in the nonaqueous electrolyte secondary batteries 1A, 1J, and 1S in which the total amount of Ni and Mn was less than 60 mol %, increase of the exposure ratio improved cycle characteristics but did not improve power characteristics.

This is considered to be because the length along the c axis of a hexagonal structure as which the crystal structure of the electrode active material was approximated was less than 14.2 Å in each of the positive electrode active materials 1a, 1j, and 1s.

Specifically, this is considered to be because of the following reasons. Since the total amount of Ni and Mn was less than 60 mol % of that of all the metal elements forming the positive electrode active material in each of the positive electrode active materials 1a, 1j, 1s, 1ab, and 1ak, crystal layers of the positive electrode active material were not likely to be orderly grown and the length along the c axis of a hexagonal structure as which the crystal structure of the positive electrode active material was approximated was insufficient, i.e., was less than 14.2 Å. Accordingly, the distance between layers in the crystal structure of the positive electrode active material was small so that the diffusion speed of lithium ions within primary particles could not be sufficiently high. Therefore, the diffusion speed within primary particles determined the rate of movement of lithium ions resulting in that advantages obtained by increasing the exposure ratio were not apparent.

Table 2 shows results on the case of using LiCoO₂ which contains Co as a main component (i.e., the batteries 2AA, 2AJ, 2AS, 2AT, and 2AU), as a particularly obvious comparison. Even when the exposure ratio was increased, no great improvement were observed in power characteristics and cycle characteristics.

Among the nonaqueous electrolyte secondary batteries 1A through 1AA, the nonaqueous electrolyte secondary batteries 1H, 1I, 1Q, 1R, 1Z, and 1AA in each of which Ni and Mn did not have substantially the same mole fraction, in spite of high exposure ratios, power characteristics and cycle characteristics were less improved than that in the nonaqueous electrolyte secondary batteries 1B through 1E, 1K through 1N, and 1T through 1W in each of which Ni and Mn had substantially the same mole fraction and the total amount of Ni and Mn was 60 mol % or more.

This is considered to be because of the following reasons. As a first reason, if Ni and Mn do not have the same mole fraction, crystal layers of a positive electrode active material is not orderly grown so that lithium ions slowly move within the crystal even when the distance between crystal layers is 14.2 Å or more. As a second reason, if Ni and Mn do not have the same mole fraction, the electron structure of Ni and the electron structure of Mn are not changed by interaction so that it is difficult to improve the conductivity of the positive electrode active material and stability of the crystal structure thereof. For these two reasons, none of the advantage obtained by increasing the exposure ratio (i.e., improvement of power characteristics and cycle characteristics) and the advantage obtained by stabilizing the crystal structure of the positive electrode active material (i.e., suppression of Mn elution from the positive electrode active material) was apparent in the nonaqueous electrolyte secondary batteries 1H, 1I, 1Q, 1R, 1Z, and 1AA.

In the nonaqueous electrolyte secondary batteries 1F, 1G, 1O, 1P, 1X, and 1Y using the positive electrode active materials 1f, 1g, 1o, 1p, 1x, and 1y in each of which the mole fractions of Ni and Mn deviate from the same mole fraction by 10%, the degree of improvement of both power characteristics and cycle characteristics were almost equal to that in the nonaqueous electrolyte secondary batteries 1E, 1N, and 1W using the positive electrode active materials 1e, 1n, and 1w in each of which Ni and Mn have the same mole fraction. Accordingly, the case where “Ni and Mn have the same mole fraction” includes not only the case where the mole fractions of Ni and Mn are exactly the same but also the case where the mole fraction difference between Ni and Mn is 10% or less.

From the foregoing facts, it was found that power characteristics and cycle characteristics are improved to the largest extent when a positive electrode active material contains Ni and Mn having the same mole fraction, the crystal structure thereof is a rhombohedral structure, the length along the c axis of a hexagonal structure as which the crystal structure is approximated is 14.2 Å or more, and the total amount of Ni and Mn is 60 mol % or more of the amount of all the metal elements forming the positive electrode active material.

Table 1 shows that when the ratio of the average length of the primary particles along their longitudinal axes with respect to the average particle size of the secondary particles was 0.20 or more, power characteristics and cycle characteristics were improved. As the ratio of average length of the primary particles along their longitudinal axes with respect to the average particle size of the secondary particles increases, the number of primary particles exposed at the surfaces of the secondary particles increases.

When the ratio of the average length of the primary particles along their longitudinal axes with respect to the average particle size of the secondary particles is one or less, distortion of shape of the secondary particles is prevented. This is advantageous when positive electrode active material paste is prepared, when the positive electrode active material paste is applied onto a current collector and when the positive electrode active material paste is rolled to form a positive electrode after the application. Accordingly, the ratio of average length of the primary particles along their longitudinal axes with respect to the average particle size of the secondary particles is preferably one or less.

Table 1 also shows that the ratio of average length of the primary particles along their longitudinal axes with respect to the average particle size of the secondary particles is more preferably 0.3 or more. More specifically, the ratio is preferably 0.2 or more, more preferably in the range from 0.2 to 1, both inclusive, and much more preferably in the range from 0.3 to 1, both inclusive.

### Example 2

Hydroxides (i.e., constituents of a positive electrode active material) containing Ni as a main component were produced using the reactor 1 shown in FIG. 1. As the constituents, 1 mol/L of a nickel sulfate aqueous solution, 1 mol/L of a cobalt sulfate aqueous solution, a 1 mol/L of an aluminium sulfate aqueous solution (which may be replaced by 1 mol/L of a manganese sulfate aqueous solution in some cases), 5 mol/L of an ammonium aqueous solution, and 5 mol/L of a sodium hydroxide aqueous solution were continuously supplied to the reactor 1 while being stirred with the flow rates thereof controlled with pumps 4 through 8 such that the composition of a composite hydroxide to be produced was obtained. Thereafter, various composite hydroxides having different compositions were prepared in the same manner as in Example 1.

Next, these composite hydroxides were rinsed with water, dried, and then baked in the atmosphere, thereby producing a composite oxide. In this manner, various composite oxides having different ratios among Ni, Co, and Al and different secondary particle sizes were prepared.

Each of these composite oxides was mixed with lithium carbonate in such a manner that the number of moles of Li was equal to the number of moles of metal elements in the composite oxide. Then, the mixture was baked at 1100° C. in the atmosphere. Subsequently, the baked composite oxide was mixed with lithium carbonate in an amount corresponding to evaporated Li, and the mixture was baked at 1000° C. again. By changing the temperature and time of this baking, the amount of primary particles exposed at the surfaces of secondary particles was adjusted.

In this manner, positive electrode active materials 2a through 2x were obtained. Thereafter, the total cross-sectional area of primary particles exposed at the surfaces of secondary particles was obtained. Specifically, first, a large number of secondary particles were observed with a particle size distribution analyzer and a scanning electron microscope. Then, the average particle size of the secondary particles was measured with a scanning electron microscope photograph. Subsequently, the secondary particles were filled with a resin and the cut-out section of this resin was polished and observed with a scanning electron microscope. In this manner, primary particles at least partially exposed at the surfaces of the secondary particles were observed in cross sections taken at substantially the center of each secondary particle. Then, the total cross-sectional area of the primary particles at least partially exposed at the surfaces of the secondary particles was obtained.

Subsequently, the total cross-sectional area of the primary particles constituting the secondary particles was obtained so that the ratio (exposure ratio) between this total cross-sectional area and the cross-sectional area of the primary particles at least partially exposed at the surface of the secondary particles was calculated. The lengths of the primary particles along their longitudinal axes were also calculated with a cross-sectional photograph taken with a scanning electron microscope. The average particle size of the secondary particles and the average length of the primary particles along their longitudinal axes were calculated by performing image processing on cross-sectional photographs taken with a scanning electron microscope.

In addition, an X-ray diffraction analysis was performed on the positive electrode active material. With the obtained diffraction pattern, it was confirmed that the crystal structure of the positive electrode active material was a rhombohedral structure and the length along the c axis of a hexagonal structure as which the crystal structure thereof was approximated was measured. The composition and physical properties of the positive electrode active materials are shown in Table 2.

TABLE 2

| | | | | | | | average | | | | | | |
|---|---|---|---|---|---|---|---|---|---|---|---|---|---|
| | | mole | | | | primary particle | particle | longitudinal | | | | | number |
| | active | fraction % | | | | amount % at surface | size | axis | | c axis | | power | of |
| | material | Ni | Co | Al | Mn | % | μm | μm | ratio | Å | battery | % | cycles |
| comparative | 2aa | | 100 | | | 18 | 9 | 1.3 | 0.14 | 14.05 | 2AA | 85 | 110 |
| example 3 | 2ab | 50 | 50 | | | 17 | 12 | 1.2 | 0.10 | 14.12 | 2AB | 90 | 120 |
| | 2ac | 53 | 40 | 7 | | 16 | 12 | 1.0 | 0.08 | 14.19 | 2AC | 96 | 120 |
| | 2ad | 55 | 44 | 1 | | 15 | 11 | 0.5 | 0.05 | 14.13 | 2AD | 95 | 110 |
| | 2ae | 60 | 30 | 10 | | 15 | 10 | 1.0 | 0.10 | 14.24 | 2AE | 105 | 110 |
| | 2af | 70 | 25 | 5 | | 16 | 10 | 1.2 | 0.12 | 14.22 | 2AF | 100 | 120 |
| | 2ag | 81 | 15 | 4 | | 15 | 9 | 1.0 | 0.11 | 14.25 | 2AG | 107 | 120 |
| | 2ah | 85 | 10 | 5 | | 15 | 10 | 0.8 | 0.08 | 14.25 | 2AH | 108 | 120 |
| | 2ai | 70 | 15 | 5 | 10 | 14 | 11 | 0.7 | 0.06 | 14.28 | 2AI | 96 | 80 |
| comparative | 2aj | | 100 | | | 33 | 9 | 1.7 | 0.19 | 14.05 | 2AJ | 85 | 120 |
| example 4 | 2ak | 50 | 50 | | | 34 | 12 | 2.0 | 0.17 | 14.12 | 2AK | 90 | 120 |
| | 2al | 53 | 40 | 7 | | 30 | 11 | 2.0 | 0.18 | 14.19 | 2AL | 100 | 120 |
| | 2am | 55 | 44 | 1 | | 30 | 11 | 1.8 | 0.16 | 14.13 | 2AM | 100 | 120 |
| | 2an | 60 | 30 | 10 | | 29 | 10 | 1.5 | 0.15 | 14.24 | 2AN | 108 | 120 |
| | 2ao | 70 | 25 | 5 | | 30 | 10 | 1.8 | 0.18 | 14.22 | 2AO | 103 | 130 |
| | 2ap | 81 | 15 | 4 | | 31 | 9 | 1.7 | 0.19 | 14.25 | 2AP | 110 | 130 |
| | 2aq | 85 | 10 | 5 | | 30 | 10 | 1.7 | 0.17 | 14.25 | 2AQ | 109 | 120 |
| | 2ar | 70 | 15 | 5 | 10 | 27 | 11 | 1.4 | 0.13 | 14.28 | 2AR | 99 | 80 |
| comparative | 2as | | 100 | | | 42 | 9.5 | 2.4 | 0.25 | 14.05 | 2AS | 88 | 120 |
| example 5 | | | | | | | | | | | | | |
| example 2 | 2a | 50 | 50 | | | 41 | 12 | 2.4 | 0.20 | 14.12 | 2A | 100 | 140 |
| | 2b | 53 | 40 | 7 | | 44 | 10.5 | 2.4 | 0.23 | 14.19 | 2B | 110 | 160 |
| | 2c | 55 | 44 | 1 | | 45 | 11 | 2.4 | 0.22 | 14.13 | 2C | 126 | 200 |
| | 2d | 60 | 30 | 10 | | 40 | 10.5 | 2.2 | 0.21 | 14.24 | 2D | 130 | 200 |
| | 2e | 70 | 25 | 5 | | 40 | 10 | 2.0 | 0.20 | 14.22 | 2E | 128 | 210 |
| | 2f | 81 | 15 | 4 | | 42 | 10 | 2.2 | 0.22 | 14.25 | 2F | 135 | 210 |
| | 2g | 85 | 10 | 5 | | 46 | 10 | 2.5 | 0.25 | 14.25 | 2G | 133 | 210 |
| | 2h | 70 | 15 | 5 | 10 | 40 | 10.5 | 2.2 | 0.21 | 14.28 | 2H | 122 | 130 |
| comparative | 2at | | 100 | | | 62 | 9 | 3.0 | 0.33 | 14.05 | 2AT | 90 | 120 |
| example 5 | | | | | | | | | | | | | |
| example 2 | 2i | 50 | 50 | | | 65 | 12 | 3.4 | 0.28 | 14.12 | 2I | 110 | 150 |
| | 2j | 53 | 40 | 7 | | 62 | 11 | 3.4 | 0.31 | 14.19 | 2J | 116 | 190 |
| | 2k | 55 | 44 | 1 | | 66 | 11 | 3.4 | 0.31 | 14.13 | 2K | 149 | 260 |
| | 2l | 60 | 30 | 10 | | 60 | 10 | 3.0 | 0.30 | 14.24 | 2L | 153 | 250 |
| | 2m | 70 | 25 | 5 | | 60 | 10.5 | 3.1 | 0.30 | 14.22 | 2M | 150 | 260 |
| | 2n | 81 | 15 | 4 | | 65 | 9.5 | 3.1 | 0.33 | 14.25 | 2N | 156 | 260 |
| | 2o | 85 | 10 | 5 | | 63 | 10 | 3.3 | 0.33 | 14.25 | 2O | 153 | 280 |
| | 2p | 70 | 15 | 5 | 10 | 62 | 10.5 | 3.1 | 0.30 | 14.28 | 2P | 140 | 170 |
| comparative | 1au | | 100 | | | 90 | 9 | 5.0 | 0.56 | 14.05 | 2AU | 89 | 110 |
| example 5 | | | | | | | | | | | | | |
| example 2 | 2q | 50 | 50 | | | 85 | 11.5 | 4.5 | 0.39 | 14.12 | 2Q | 110 | 150 |
| | 2r | 53 | 40 | 7 | | 90 | 10.5 | 4.6 | 0.44 | 14.19 | 2R | 114 | 180 |
| | 2s | 55 | 44 | 1 | | 82 | 10.5 | 4.6 | 0.44 | 14.13 | 2S | 146 | 250 |
| | 2t | 60 | 30 | 10 | | 80 | 10 | 4.4 | 0.44 | 14.24 | 2T | 150 | 250 |
| | 2u | 70 | 25 | 5 | | 84 | 10 | 4.4 | 0.44 | 14.22 | 2U | 146 | 260 |
| | 2v | 81 | 15 | 4 | | 85 | 10 | 5.0 | 0.50 | 14.25 | 2V | 147 | 270 |
| | 2w | 85 | 10 | 5 | | 86 | 10.5 | 4.0 | 0.38 | 14.25 | 2W | 145 | 280 |
| | 2x | 70 | 15 | 5 | 10 | 82 | 10 | 4.0 | 0.40 | 14.28 | 2X | 139 | 170 |

### Comparative Example 3

In the same manner as in Example 2, composite oxides were prepared. Each of these composite oxides was mixed with lithium carbonate in such a manner that the number of moles of Li was equal to the number of moles of metal elements in the composite oxide. Thereafter, the mixture was baked at 950° C. in the atmosphere, and then was baked at 750° C. again.

In this manner, positive electrode active materials 2aa through 2ai were prepared. In these positive electrode active materials, primary particles were not sufficiently grown as described in Patent Document 1 and secondary particles were clusters of very fine primary particles.

In the same manner as in Example 2, the exposure ratio, the average particle size of the secondary particles, the average length of the primary particles along their longitudinal axes, the ratio of the average length of the primary particles along their longitudinal axes with respect to the average particle size of the secondary particles, and the length along the c axis of a hexagonal structure as which the crystal structure of each positive electrode active material was approximated were obtained. The results are shown in Table 2.

### Comparative Example 4

In the same manner as in Example 2, composite oxides were prepared.

Each of these composite oxides was mixed with lithium carbonate in such a manner that the number of moles of Li was equal to the number of moles of metal elements in the composite oxide. Then, the mixture was baked in the atmosphere. Subsequently, the baked composite oxide was mixed with lithium carbonate in an amount corresponding to evaporated Li, and the mixture was baked again. By changing the temperature and time of this baking, the amount of primary particles exposed at the surfaces of secondary particles was adjusted. In this manner, positive electrode active materials 2aj through 2ar were prepared.

Then, in the same manner as in Example 2, the exposure ratio, the average particle size of the secondary particles, the average length of the primary particles along their longitudinal axes, the ratio of the average length of the primary particles along their longitudinal axes with respect to the average particle size of the secondary particles, and the length along the c axis of a hexagonal structure as which the crystal structure of each positive electrode active material was approximated were obtained. The results are shown in Table 2.

### Comparative Example 5

In the same manner as Example 2 except for using only a cobalt sulfate aqueous solution as a sulfate solution of a metal element, a Co oxide was prepared. This Co oxide was mixed with lithium carbonate in such a manner that the number of moles of Li was equal to the number of moles of a metal element in the Co oxide. Then, the mixture was baked in the atmosphere. Subsequently, the baked oxide was mixed with lithium carbonate in an amount corresponding to evaporated Li, and the mixture was baked again. By changing the temperature and time of this baking, the amount of primary particles exposed at the surfaces of secondary particles was adjusted. In this manner, positive electrode active materials 2as, 2at, and 2au were prepared.

Then, in the same manner as in Example 2, the exposure ratio, the average particle size of the secondary particles, the average length of the primary particles along their longitudinal axes, the ratio of the average length of the primary particles along their longitudinal axes with respect to the average particle size of the secondary particles, and the length along the c axis of a hexagonal structure as which the crystal structure of each positive electrode active material was approximated were obtained. The results are shown in Table 2.

Using these positive electrode active materials 2a through 2x and 2aa through 2au, nonaqueous electrolyte secondary batteries 2A through 2X and 2AA through 2AU were prepared in the same manner as in Example 1.

Next, in the same manner as in Example 1, power characteristics and cycle characteristics were measured for the nonaqueous electrolyte secondary batteries 2A through 2X and 2AA through 2AU. The results are shown in Table 2. In Table 2, concerning power (%), the value of power of the nonaqueous electrolyte secondary battery 2AF is shown as 100.

Table 2 shows that the nonaqueous electrolyte secondary batteries 2A through 2X fabricated by using the positive electrode active materials of Example 2 (i.e., the positive electrode active materials 2a through 2x) exhibited further improved power characteristics and cycle characteristics, as compared to the nonaqueous electrolyte secondary batteries 2AA through 2AU fabricated by using the positive electrode active materials of Comparative Examples 3 through 5 (i.e., the positive electrode active materials 2aa through 2au). This is considered to be because of the same reason as in Example 1.

Experimental results are now discussed by comparing the results on the nonaqueous electrolyte secondary batteries 2A through 2X of Example 2 and the results on the nonaqueous electrolyte secondary batteries 2AS, 2AT, and 2AU of Comparative Example 5.

In the nonaqueous electrolyte secondary batteries 2AS, 2AT, and 2AU, in spite of high exposure ratios, no improvement was observed in cycle characteristics and power characteristics. It is considered that the cycle characteristics were not improved in spite of high exposure ratios because the absence of Ni in the positive electrode active materials suppressed occurrence of cracks of the positive electrode active materials caused by charge and discharge cycles, as compared to the case where the positive electrode active materials contained Ni.

The reason why the power characteristics were not improved in spite of high exposure ratios is considered to be as follows. That is, the absence of Ni in each of the positive electrode active materials prevented sufficient increase in the length of the crystal structure of the positive electrode active material along the c axes so that the distance between layers in the crystal structure was small. Thus, the speed of diffusion of lithium ions within primary particles was not sufficiently increased. Accordingly, the diffusion speed of lithium ions within primary particles determined the rate of lithium ion diffusion. As a result, advantages obtained by increasing the exposure ratio were not apparent.

In the positive electrode active materials 2a, 2b, 2i, 2j, 2p, and 2r of the nonaqueous electrolyte secondary batteries 2A, 2B, 2I, 2J, 2Q, and 2R of Example 2, the Ni content of each positive electrode active material was less than 55% and the length along the c axis of a hexagonal structure as which the crystal structure of each positive electrode active material was approximated was less than 14.13 Å. In these nonaqueous electrolyte secondary batteries 2A, 2B, 2I, 2J, 2Q, and 2R, even when the exposure ratio was increased, power characteristics and cycle characteristics were less improved than those in the other nonaqueous electrolyte secondary batteries of Example 2.

The reason why power characteristics were less improved in the nonaqueous electrolyte secondary batteries 2A, 2B, 2I, 2J, 2Q, and 2R is considered to be as follows. The low Ni contents in the positive electrode active materials prevented orderly growth of the crystal structures and also prevented sufficient increase of the length along the c axis of each of the crystal structures of the positive electrode active materials, thus making it difficult to sufficiently increase the diffusion speed of lithium ions within primary particles. Accordingly, the diffusion speed within primary particles determined the speed of movement of lithium ions so that advantages obtained by increasing the exposure ratio were not apparent.

The reason why cycle characteristics were not greatly improved in the nonaqueous electrolyte secondary batteries 2A, 2B, 2I, 2J, 2Q, and 2R is that when the Ni content is lower than the Co content in a positive electrode active material, occurrence of cracks in the positive electrode active material is suppressed even through charge and discharge cycles.

The foregoing results shows that power characteristics and cycle characteristics are improved to the largest extent when a positive electrode active material contains Ni and Co, the crystal structure thereof is a rhombohedral structure, the length along the c axis of a hexagonal structure as which the crystal structure is approximated is 14.13 Å or more, and the content of Ni as a metal element is 55 mol % or more.

Among the nonaqueous electrolyte secondary batteries 2C through 2H, 2K through 2P, and 25 through 2X, the experimental results on the nonaqueous electrolyte secondary batteries 2H, 2P, and 2X and the experimental results on the other nonaqueous electrolyte secondary batteries were compared. Each of the nonaqueous electrolyte secondary batteries 2C through 2H, 2K through 2P, 2S through 2X included a positive electrode active material containing Ni and Co, the crystal structure thereof was a rhombohedral structure, the length along the c axis of a hexagonal structure as which the crystal structure was approximated was 14.13 Å or more, and the amount of Ni contained in the positive electrode active material was 55 mol % or more of all the metal elements constituting the positive electrode active material. The nonaqueous electrolyte secondary batteries 2H, 2P, and 2X included positive electrode active materials containing Mn (i.e., the positive electrode active materials 2h, 2p, and 2x). It was found that in the nonaqueous electrolyte secondary batteries 2H, 2P, and 2X using the Mn-containing positive electrode active materials 2h, 2p, and 2x, cycle characteristics were poorer than those of the nonaqueous electrolyte secondary batteries using the positive electrode active materials containing no Mn, in spite of high exposure ratios. This is considered to be because Ni and Mn did not have substantially the same mole fraction so that the crystal structure of the positive electrode active material was not stabilized at an atomic level, resulting in elution of Mn from the positive electrode active material.

In addition, as shown in Table 2, when the ratio of the average length of the primary particles along their longitudinal axes with respect to the average particle size of the secondary particles was 0.2 or more, power characteristics and cycle characteristics were improved. This is because of the reasons already explained in Example 1.

For the foregoing reasons, the nonaqueous electrolyte secondary batteries of Example 2 exhibit improved power characteristics and cycle characteristics.

The average length of the primary particles along their longitudinal axes is preferably 2 μm or more. If the average length of the primary particles along their longitudinal axes is small, the average particle size of the secondary particles needs to be small in order to set the ratio of the average length of the primary particles in their longitudinal axes with respect to the average particle size of the secondary particles in the range from 0.2 to 1, both inclusive. When the primary particle size and the secondary particle size decrease, the specific surface area of the secondary particles increases. Accordingly, the area where the positive electrode active material is in contact with the nonaqueous electrolyte becomes very large so that the elution speed of metal elements at the surfaces of the secondary particles increases, resulting in degradation of life characteristics of the nonaqueous electrolyte secondary battery. In view of this, the average length of the primary particles along their longitudinal axes is preferably 2 μm or more. Further, to suppress decrease in size of the secondary particles, the average length of the primary particles along their longitudinal axes is preferably 3 μm or more.

In Examples 1 and 2, the baking process of baking a mixture of a composite oxide and Li ions was performed twice, thereby obtaining a positive electrode active material. Production of a positive electrode active material with the above method makes the size of primary particles larger than a method in which the baking process is performed only once as described in Comparative Example 1.

A positive electrode active material may be produced with a method except for production methods described in Examples 1 and 2. Specifically, a composite hydroxide may be prepared at a lower temperature in a longer residence time (i.e., a period of time before an aqueous solution in an amount equal to the volume of the reactor 1 is supplied), using lower concentrations of metal salt aqueous solutions, a sodium hydroxide aqueous solution, and an ammonium solution. Then, the size of primary particles in the composite hydroxide is increased. The use of such a composite hydroxide enables the structure of the positive electrode active material of the present invention to be obtained even with a conventional method in which Li is introduced in a single step as in Comparative Example 3.

In the case where a composite carbonate is used as a constituent instead of a composite hydroxide, the structure of the positive electrode active material of the present invention can be obtained even with a conventional method in which Li is introduced in a single step. This is because fabrication of a lithium composite oxide using a carbonate as a constituent allows formation of primary particles having a relatively large size.

### INDUSTRIAL APPLICABILITY

A positive electrode active material for a nonaqueous electrolyte secondary battery and a nonaqueous electrolyte secondary battery using the positive electrode active material according to the present invention exhibit excellent power characteristics and long life of charge and discharge cycles and, therefore, are useful for power supplies for, for example, cellular phones, notebook computers, power tools, electric vehicles, hybrid electric vehicles, and home appliances.

1. A Ni-containing positive electrode active material for a nonaqueous electrolyte secondary battery, wherein the positive electrode active material is formed of secondary particles each constituted by aggregated primary particles, and
in cross sections of the secondary particles, a total cross-sectional area of part of the primary particles at least partially exposed at the surfaces of the secondary particles is at least 40% of a total cross-sectional area of the primary particles constituting the secondary particles.

2. The positive electrode active material of claim 1, wherein in the cross sections of the secondary particles, the total cross-sectional area of the primary particles at least partially exposed at the surfaces of the secondary particles is at least 60% of the total cross-sectional area of the primary particles constituting the secondary particles.

3. The positive electrode active material of claim 1, wherein in the cross sections of the secondary particles, a ratio of an average length of the primary particles along their longitudinal axes with respect to an average particle size of the secondary particles is at least 0.2.

4. The positive electrode active material of claim 1, containing Ni and Mn having substantially the same mole fraction.

5. The positive electrode active material of claim 4, wherein the crystal structure of the positive electrode active material is a rhombohedral structure,
the length along a c axis of a hexagonal structure as which the crystal structure is approximated is at least 14.2 Å, and
the total amount of Ni and Mn contained in the positive electrode active material is at least 60 mol % of the amount of all the metal elements contained in the positive electrode active material.

6. The positive electrode active material of claim 1, wherein the positive electrode active material contains Ni and Co,
the crystal structure of the positive electrode active material is a rhombohedral structure,
the length along a c axis of a hexagonal structure as which the crystal structure of the positive electrode active material is approximated is at least 14.13 Å, and
the amount of Ni contained in the positive electrode active material is at least 55 mol % of the amount of all the metal elements contained in the positive electrode active material.

7. A nonaqueous electrolyte secondary battery, using the positive electrode active material of claim 1.
